(19) United States
(12) Patent Application Publication
(10) Pub. No.: US 2004/0260578 A1
(43) Pub. Date: Dec. 23, 2004

(54) Real estate devaluation insurance

(76) Inventor: Mengcheng Jin, Studio City, CA (US)

Correspondence Address: MENGCHENG JIN, 11685 PICTURESQUE DRIVE, STUDIO CITY, CA, 91604, US

(21) Appl. No.: 10/463,804

(22) Filed: Jun. 17, 2003

(51) Int. Cl. G06F 17/60

(52) U.S. Cl. 705/4; 705/1

(57) ABSTRACT

An insurer insures a real estate investor against a market devaluation of real property. A Shelter Value is established in the insurance contract either by the purchase price or an initial appraisal of the real property. If the real estate investor sells the property at a market loss, the insurer reimburses the client the difference between the Shelter Value and the sale price of the property. The insurer is protected against fraudulent, negligent, or bad faith conveyances by establishing within the contract a means for determining a Maximum Reimbursable Loss according to a Final Market Value of the home. If the sale price is greater than the Shelter Value, no indemnity is paid the client. If the sale price is below the Shelter Value but above the Final Market Value, the client is awarded the difference between the Shelter Value and the sale price. If the sale price is below the Final Market Value, the Maximum Reimbursable Loss that can be paid as an indemnity is the difference between Shelter Value and the Final Market Value. The Final Market Value can be determined by a Terminal Appraisal of the property at the time of the sale, or alternatively, by the equation

Final Market Value=Shelter Value×(ASFV2/ASFV1)

where ASFV2 and ASFV1 are respectively the Average Square Foot Values of similar property at the time of sale and the time of purchase of the client's property.

### BACKGROUND OF THE INVENTION

1. Field of the Invention

This invention relates to the field of real property insurance. More specifically, the present invention is directed to a method for insuring real property owners against a market place devaluation of real estate value.

2. Description of Related Art

Owing both to inflation, and to regional commercial development, real property normally increases in value over time. Occasionally however, the value of real property decreases. There are a variety of political, social and economic events that can cause fluctuations resulting in suppressed real estate values lasting for varying periods of time. Some fluctuations can be caused by an industry wide recession such as experienced in the oil and gas sectors in the 1980s, or the downturn in certain high tech sectors at the beginning of the twenty first century. Global economic shifts, such as the increased production of high quality low cost steel in the Pacific Rim can cause economic displacement in regions with economies fueled by steel production. Sometimes, such downturns can be permanent.

Property owners desiring to sell their property usually attempt to outlast short term real estate recessions. If they succeed, they can eventually sell their property for more than the original purchase amount. However, when homeowners are transferred by their employer to a new geographic region, accept a new job at a new geographic location, lose their job, or face other exigent circumstances, a homeowner can be forced to sell their home for less than the original purchase price. Other circumstances can similarly affect commercial real estate owners. This loss must be absorbed by someone. If the sale value of real property exceeds debt owed to the mortgage lender, the property owner will be able to pay off the mortgage note, but will suffer capital loss in the investment. However, if a sale value of real property is for less than the mortgage owed on the property, the property owner is not able to pay off the mortgage, and the mortgage lender is left at a loss.

To protect themselves against such losses, mortgage lenders may require at least twenty percent down payment on property, thereby insuring themselves against real estate downturns of less than twenty percent. This steep down payment, however, served to restrict home ownership from a large segment of the population, particularly first time home buyers. In order to attract first time home buyers to the market, the industry developed Private Mortgage Insurance. Private Mortgage Insurance policies insure mortgage lenders against potential loss when a mortgage borrower is forced to sell a home at a value less than the outstanding mortgage debt.

A unique feature of private mortgage insurance is that it exclusively benefits a mortgage lender. If the value of a home sale is sufficient to cover the outstanding mortgage debt, any loss incurred by the borrower is the borrower's problem. Mortgage bankers, however, are not the only parties interested in the value of a home. Home owners themselves often rely on the value of their home for security in retirement, and corporations depend on the value of their real estate holdings to stabilize occasional market downturns. Because the architecture of private mortgage insurance is not directed to protecting the consumer, homeowners and other real estate owners are left unprotected from a market place devaluation of what is usually their most valuable investment.

U.S. patent application No. 20030023462 filed on Jan. 30, 2003 by Heilizer is directed to an insurance policy that insures the property owner that his property will increase in value at a minimum rate.

Heilizer does not offer devaluation insurance, but rather, creates a securities instrument guaranteeing an appreciation at a predetermined rate. This rate may be a fixed interest rate such as 0.5%, 2%, 3.5% etc. Alternatively, Heilizer envisions fixing the appreciation to various index rates, including LIBOR, Treasury Rates, etc. Additionally, the Heilizer application provides that if the policy is still active when the property owner desires to sell the house, the property owner is guaranteed that the insurance provider will purchase the home at the predetermined price. Alternatively, if the value of the home has lagged the insured value, then the property owner can require the insurer purchase the house at the predetermined value, less any transaction costs. The insurer therefore becomes a real estate holding corporation, taking receivership of any properties for which policies are written.

There is therefore a need for an insurance product that is written for the benefit of the property owner. There is also a need for an insurance product that does not require an insurer to take receivership of a property if the property loses value. There is further a need for a product insuring real property against devaluation. Additionally, there is a need for a product that functions like an insurance policy and not like a securities instrument, and that builds into it safeguards against insurance fraud and bad faith or negligent conveyances.

### SUMMARY OF THE INVENTION

The present invention is directed to an insurance product that protects a real estate investor against a devaluation in a market value of a real estate investment. The insurance product functions like an insurance policy and not like a securities instrument, and is written for the benefit of the property owner, not simply the mortgage lender. The insurance product does not require an insurer to take receivership of a property if the property loses value. Additionally, the insurance product of the present invention has safeguards against insurance fraud and bad faith or negligent conveyances.

A method of protecting a real estate investor comprises the steps of offering a real estate investor an insurance contract insuring against a loss incurred through the sale of real property. A loss is defined as a sale of the real property at a Future Sale Price below a Shelter Value, a Basic Loss being defined according to the equation:

Basic Loss=Shelter Value minus Future Sale Price

However, an upper limit is placed on an indemnity that can be awarded to a client according to the equation:

Maximum Reimbursable Loss=Shelter Value minus Final Market Value

The Shelter Value for the real property is established on an initial day. The Shelter Value can be determined from an appraisal value, or from a purchase price of the real property. The Final Market Value can be determined according to one of two methods. According to the first method, when the client sells the real property, a Terminal Appraisal Value by a qualified appraiser establishes the Final Market Value.

An alternative method for determining the Final Market Value is performed according to the following steps: A reliable source is identified for determining the Average Square Foot Value of property of the same type as the real property being insured. A first Average Square Foot Value, “ASFV1,” is determined for real property of the same type as the client's real property type in a predetermined region proximate the client's real property and proximate the initial day. A second Average Square Foot Value, “ASFV2,” is determined for real property of the same type as the clients real property in the predetermined region on a day proximate the date of sale. The alternative Final Market Value “FMV” of the real property is thus determined according to the equation:

FMV=Shelter Value×(ASFV2/ASV1)

If the Future Sale Price is greater than the Final Market Value but less than the Shelter Value, the indemnity paid the real estate investor is derived from the Basic Loss. If the Final Market Value is greater than or equal to the Future Sale Price but less than the Shelter Value, the indemnity paid to the real estate investor is derived from the Maximum Reimbursable Loss. According to the preferred embodiment, the first method for determining the Final Market Value is a default method, and the alternative method as described above is used only to settle disputes arising from the first method. However, embodiments are envisioned wherein the alternative method is used as the default method for establishing the Final Market Value.

The above method provides for adjusting the indemnity by subtracting a deductible amount from the Basic Loss or the Maximum Reimbursable Loss, and/or paying a percent of the face amount of the indemnity according to a percent coverage clause in the insurance contract.

### BRIEF DESCRIPTION OF THE DRAWINGS

The novel features which are considered characteristic for the invention are set forth in the detailed description and the appended claims. The invention itself, however, both as to its construction and its method of operation, together with additional objects and advantages thereof, will be best understood from the following description of the specific embodiments when read and understood in connection with the accompanying drawing.

FIG. 1 is a flow chart illustrating various steps within the application of the present invention.

### DETAILED DESCRIPTION OF THE PREFERRED EMBODIMENTS

As used herein, the terms “consumer,” “owner,” “buyer,” “seller,” “real estate investor” and “client” are directed to a consumer, including homesteaders and corporations seeking to acquire or sell real property, or who are otherwise have an insurable interest in the real property. Accordingly, the terms “consumer,” “seller, “buyer,” “investor” and “client” do not refer to a bank, mortgage provider, lender or lien holder providing financing of property, or acting as a surety for purchase of property, even if said bank, lender or mortgage provider possesses a recorded or unrecorded legal interest in the property. As used herein, the term “client” refers to a party contracting to purchase, paying premiums upon, or named as a beneficiary of an insurance policy as envisioned in the present invention. Accordingly, the “purchase” or “sale” of real estate by a “client” distinguishes the seller from the buyer in a specific transaction. Also as used herein, the terms “bank,” “mortgage provider,” “lender,” or similar terms refer to a party financing the acquisition of property, and are used interchangeably.

The Basic Product

The present invention is directed to a form of real estate insurance that ensures against a devaluation of real property. According to the basic product, when a client purchases real property, an agent such as a realtor, mortgage lender, or any other party properly licensed, offers a property value insurance policy to the client according to the present invention. The policy provides that if the client sells the real property during a downturn in market value and suffers a loss, the insurance company will reimburse or indemnify the client against the devaluation of the real property during the downturn in market value.

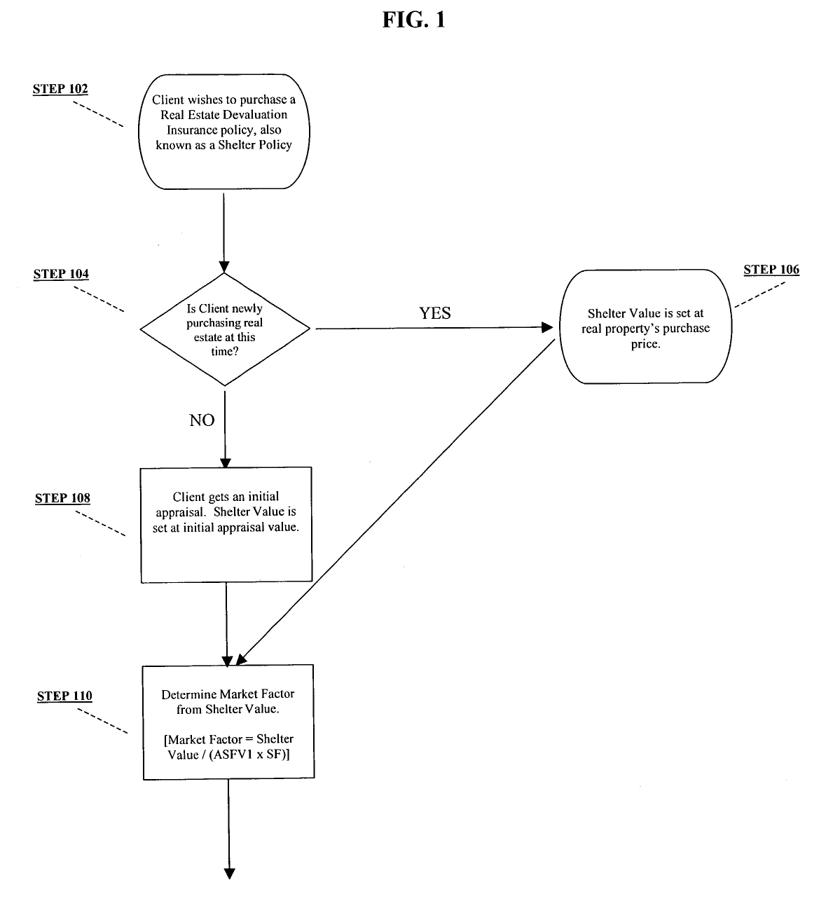

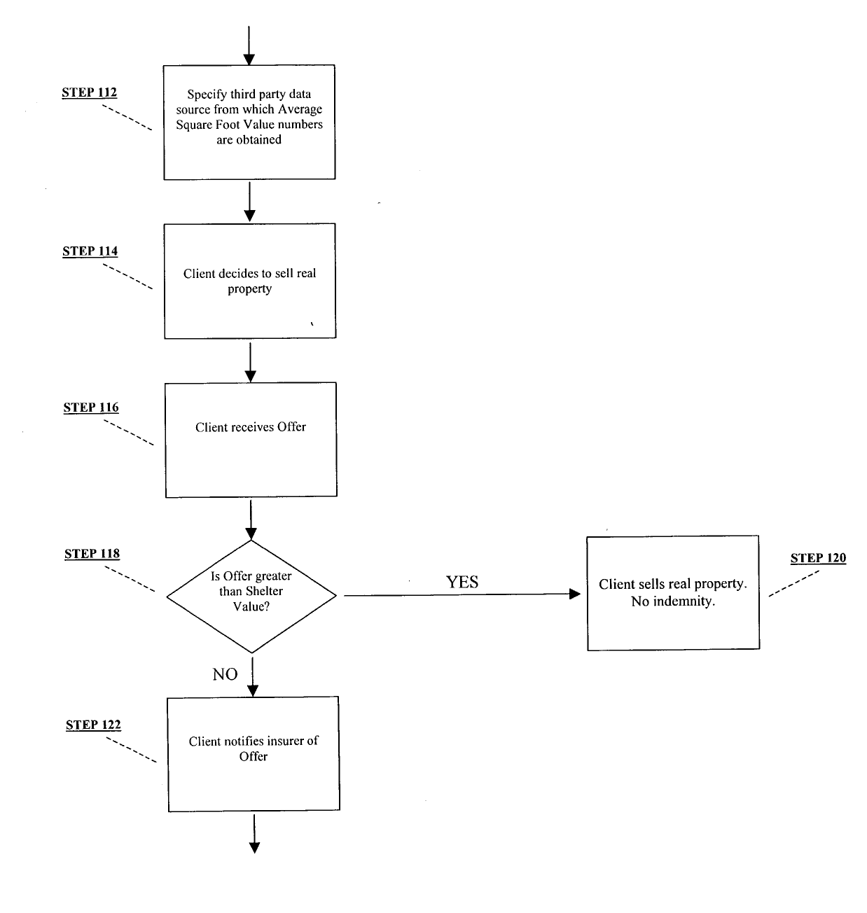

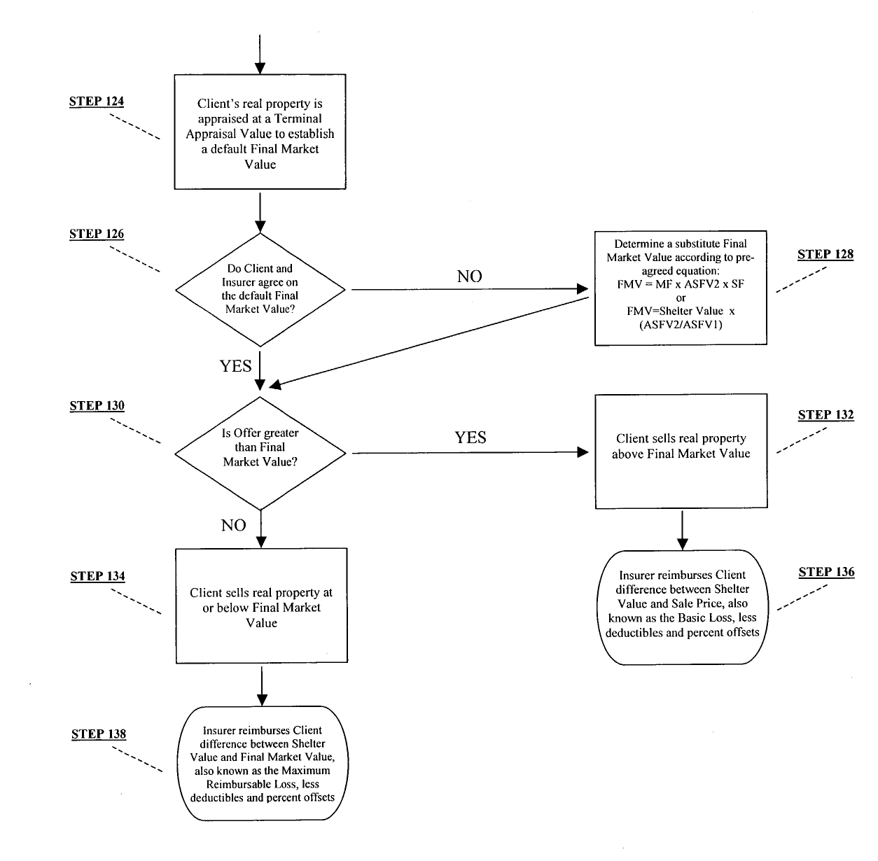

FIG. 1 is a flow chart directed the basic insurance product of the present invention.

According to step 102, a client wishes to purchase a real estate Shelter Policy providing real estate devaluation protection as described herein.

According to step 104, it is determined whether the client is a real estate buyer seeking to secure a real estate Shelter Policy concurrent with, and contingent with the client's closure on the real property purchase. Alternatively, the client can be an existing property owner desiring to purchase a real estate Shelter Policy for sheltering the recent appraisal value of the client's real property. The present product can be used in conjunction with home purchases, commercial real estate, and land purchases, as well as prior ownership of these.

According to the step 106, if a client is newly purchasing real estate, the insurance policy will preferably require that the Shelter Value of the policy is the real estate purchase price. However, the present invention envisions other means for a real estate purchaser to establish a Shelter Value, including seeking an appraisal of the property.

According to the step 108, if the client is already a real property owner and desires to purchase a real estate Shelter Policy on the property, the client is required to secure an initial appraisal of the real property, thereby establishing the policy's Shelter Value. Specific countries and/or administrative districts may include government appraisers, private appraisers, or both. For example, within the United States, appraising entities include the American Society of Appraisers, the National Association of Realtors, appraisers possessing an RAA or GAA certification, the Appraisal Institute, the National Association of Independent Fee Appraisers, and the National Association of Master Appraisers. Additionally, certain appraising entities can have sub-specialties and certifications. For example, one entity may issue separate certifications for appraising undeveloped land, commercial realty, and residential property. The real estate Shelter Policy, or an official publication of the insurance company underwriting the Shelter Policy, will advantageously designate those appraisal agencies, including independent agents, recognized by the insurance underwriter in the formation of real estate shelter policies. By designating approved appraisal agents and entities within the policy, the present invention can limit or reduce disputes or fraud which might occur otherwise be perpetrated by or against the insurance underwriter.

Grace Period Following Purchase

The circumstance is envisioned wherein a real estate owner elects not to secure a real estate Shelter Policy at the time of a purchase, but wishes to do so at some later time without having to undergo an initial appraisal. Embodiments are therefore envisioned wherein an insurer will allow a real property owner to purchase a real estate Shelter Policy within a period of time following the purchase of the underlying real property for which the client subsequently seeks protection. This period of time is known as a grace period. According to the preferred embodiment, the grace period is a fixed period of time, such as thirty days, sixty days, ninety days, 180 days, or one year. However, embodiments are envisioned wherein the grace period can be defined, or delimited by events, such as market volatility, interest rates, war, political turmoil, or other events. According to the preferred embodiment, the grace period is only open to purchasers who were offered a real estate Shelter Policy at the time of the initial purchase. The grace period will advantageously be spelled out in the policy, along with circumstances which can terminate the offer, such as war, unemployment, or other triggers.

The event triggering the beginning of the grace period is subject to the laws and traditions of real estate sales in various regions and countries. According to many cultures, however, a purchase agreement or mortgage contract, under various names, is signed prior to the actual “closing” or transfer of the real estate deed. This mortgage contract establishes a binding purchase price, and binds the parties to go through with a real estate transfer provided financing and other stated conditions materialize. According to the preferred embodiment, in those transactions wherein a binding purchase agreement establishes a purchase price prior to the actual closing, the grace period will begin from the signing of the agreement. However, embodiments are envisioned wherein the grace period begins to run from the time of the actual “closing” to transfer of the deed to the property. Additionally, in view of the potential for variations in real estate laws in various countries and territories throughout the world, the present invention anticipates using other events not herein mentioned as the trigger of the grace period.

Safeguards Against Fraud

Safeguards must be put in place to prevent insurance fraud, as can be understood by the following example. A parent purchases a home for one million dollars. The parent's child marries the following year, and the parent sells the child the home at five hundred thousand dollars. The parent has incurred a five hundred thousand dollar loss in the sale to the child. If no safeguards were in place, the purchase price and sale price of homes could be manipulated in this manner, resulting in a five hundred thousand dollar insurance claim by the parent for the loss incurred in the sale of the home. For this reason, the present invention is directed to a market value loss, and not simply any loss in value due to negligence, incompetence, of a fraudulent sale and claim by a property owner.

Establishing the Initial Market Factor

One safeguard against claim disputes is to establish a “Market Factor” for the property at the time of the initial purchase of the insurance policy by the client. According to the step 110, the Market Factor is determined by first determining the Average Square Foot Value or “ASFV” of property proximate the property being underwritten by the real estate Shelter Policy. The proximity is according to factors decided by the entity publishing the ASFV, and may be based on zip codes, counties, or other definable boundaries or areas. Within the United States, one or more professional realty organizations determine ASFVs, and these values are also published in various recognized periodicals.

Because the ASFV for a particular type of real estate in a particular area fluctuates over time according to the market, the Average Square Foot Value used in the initializing of the real estate Shelter Policy will preferably be fixed according to the same date the Shelter Value for the policy is determined. If the Shelter Value is obtained by an initial appraisal, the ASFV used to initialize the policy will thus be determined according to the day of the initial appraisal. If the Shelter Value of the property is established according to the purchase price of the property, the ASFV used to initialize the policy will thus be determined according to the effective purchase date. The effective purchase date is preferably the date a contract was signed establishing the sale price of the real property. However, alternative dates such as the date of “closing” on the property are also envisioned for establishing the effective purchase date. The Average Square Foot Value used to initialize the policy is herein designated as ASFV1.

The Market Factor of real property is derived according to equation 1 below:

MF=SV/(ASFV1×SF) 1)

wherein MF is the Market Factor, SV is the Shelter Value of the policy, ASFV1 is the Average Square Foot Value of real estate of the same kind proximate the client's real property on the same day the Shelter Value of the policy was established. SF is the square footage of the property being insured. For single family dwellings, commercial property, and other properties having “improvements” (buildings) on them, the square footage “SF” will normally refer to the square footage of the dwelling, not the lot. For example, a client establishes a Shelter Value of $300,000 for a 1,500 sq. ft. piece of real property. A major metropolitan newspaper in the area publishes ASFVs for area real estate. The ASFV for the same type of real estate proximate the client is 175 dollars per square foot. Applying the above formula,

MF=$300,000/(1,500×175)=1.143.

This means that the client's realty is 1.143 times higher than the Average Square Foot Value in the same area. As discussed below, this value is used to establish the value of a claim against the policy at the time of sale of the home or property, serving both to prevent fraud, and to simplify the resolution of claim disputes.

The MF or Market Factor is therefore a ratio of the square foot value of the client's dwelling, shop, or other real estate entity compared with the Average Square Foot Value of real estate in the immediate area. In the above example, the value greater than one may be due to a variety of factors, such as a larger yard, better view, proximity to the beach, quality of building materials and amenities in the house, etc. This remains true whether the Market Factor is directed to the square footage of a single family dwelling, commercial real estate, or undeveloped property. It will be understood that the square footage factor “SF” above is algebraically factored out in a final equation, and that the above equation is therefore exemplary of one embodiment.

ASFV Source

As noted, the Market Factor is preferably relevant only in those circumstances wherein a dispute arises under a contract claim. Additionally the ASFV acts as a safeguard against real estate speculation, bidding wars, or other circumstances that serve to inflate the initial purchase price. If needed, a calculation using the ASFV1 above, or the Market Factor, will have to be performed at the time of the sale of the property. Because of this, an objective means for determining the ASFV is necessary. Otherwise, in disputes, a client could proffer an “Average Square Foot Value” (ASFV) deliberately chosen to work to their advantage in the claim settlement. As noted above, there are professional realty organizations that provide ASFV numbers and publish them in major newspapers and periodicals. According to the step 112, therefore, the Shelter Value insurance contract will advantageously specify the source from which subsequent ASFV numbers are to be obtained in the settlement of disputes. Because it is possible that the ASFV source specified in the policy could be purchased and renamed in a corporate merger, sold in bankruptcy, or any other number of contingencies, the shelter insurance policy or contract will advantageously set forth procedures and/or alternative sources in lieu of such a contingency.

As discussed above, the policy specifies that, if the client resells the property at a market value loss, the insurer will reimburse the client an amount related to the loss. It is envisioned however that the present invention can offer insurance coverage for the entire “loss” suffered in a property sale, or can alternatively reduce premium costs by reducing the potential indemnity or reimbursement awarded to a real client who sells the underlying real property at a loss. Consider the example of a client who insures real property at a Shelter Value of one million dollars. The client then resells the property for nine hundred thousand dollars, losing one hundred thousand dollars in the process. At a flat rate, the client would receive an indemnity of one hundred thousand dollars, an amount equal to the total loss.

Deductibles

To reduce the cost of premiums, a policy can be written with a deductible, which reduces the overall cost of the policy. For example, the client decides that a twenty five thousand dollar deductible will lower premiums significantly, and decides that this risk is acceptable. The policy is written according to these terms. In the above example wherein the client suffers a one hundred thousand dollar loss, the indemnity awarded under the same contract is reduced to seventy five thousand dollars.

Coverage Percentage

In addition to, or in lieu of a deductible, the insurance policy could be written such that, in the event of a loss, the client would receive an indemnity equal to a percent of the loss. For example, if the client purchased a policy for zero deductible, but a ninety percent coverage, the client would be ensured for ninety percent of the loss. Using the above example of a one hundred thousand dollar loss, no deductible, and a coverage percentage of ninety percent, the client would be awarded an indemnity of ninety thousand dollars by the insurance company. Concurrent deductible and discount percentages are envisioned within the scope of the present invention. As discussed below, the “loss” adjusted by a percent coverage and/or by a deductible can be the lesser of the Basic Loss and the Maximum Reimbursable Loss. The Basic Loss is the difference between the Shelter Value and a Sale Price of the property, whereas a Maximum Reimbursable Loss can be determined from any number of policy limits and formulas governing policy limits, as established by the Final Market Value.

Premium Payments

The insurance contract of the present invention will preferably be for a predetermined period. The period of a contract will be for at least one month, and, according to the preferred embodiment, the period of a contract will be for one year. During the period of a contract, annual premiums, deductibles, coverage percentage and the Shelter Value will remain constant. Premium payments for the insurance policy are preferably paid on a monthly basis. However, variations are envisioned, including an “up-front” payment for a predetermined term, or accelerated payments, such as a payment schedule wherein a policy holder pays for six months of premiums in a four month period.

Policies can be extended or renewed. The renewal or extension will preferably continue seamlessly from the termination of an earlier policy, effective immediately upon the termination of a previous period, thereby ensuring that the client is not uninsured for even a day. Auto-renewal clauses are envisioned according to one embodiment, wherein if premiums are not raised more than an amount specified within the policy, and no notice of termination is provided by the client to the insurer, a new policy is deemed in force upon the termination of the previous policy term. A new or renewed policy will preferably have new premiums calculated from a variety of factors discussed below. A new or renewed policy can also have a different deductible value and/or a different percent coverage. According to one embodiment, the renewed policy will incorporate the same Shelter Value as the previous policy. However, embodiments are envisioned wherein a new Shelter Value can be determined by a new assessment of property values, or even determined by a mathematical formula using the previous Shelter Value as a starting point for the calculation.

Cost of Premiums

According to the preferred embodiment, the premium is established from a variety of factors, including but not limited to the Shelter Value, market volatility at the time the policy is established, the location of the real property, government, banking and securities statistics, and government decrees, including judicial, legislative and executive decrees.

The government and banking statistics affecting the cost of insurance premiums can include, but are not limited to government unemployment statistics, government durable goods statistics, interest rates established by the Federal Reserve, and London Inter-Bank Interest Rates. Securities statistics include, but are not limited to corporate reports and forecasts of a corporation having a predetermined number of employees within a predetermined distance of said real property, and performance statistics of a securities index.

Real estate “types” affecting premium costs can be segregated into, but are not limited, to single family dwellings, duplexes, town houses, condominiums, apartment complexes, commercial property, office space, warehouses, undeveloped lands, wet lands, timberland, and beach front property.

Government decrees affecting premium rates can be factored into a volatility value, or considered independently. These decrees include both accomplished decrees such as an existing zoning ordinance, and “docketed” or “pending” decrees such as undecided court cases. The decrees can involve any branch of government, including judicial decrees, legislative decrees at any level from city assembly and zoning ordinances to national or federal legislation, and executive decrees and policies such as wet land and timber policies. Other examples of government decrees used to establish premium costs include, but are not limited to decrees related to urban lending and “redlining,” the establishment of government subsidized or low cost housing near the client's property, decrees related to landfill and refuse areas, power generation, storage of nuclear waste, eminent domain decrees, land conservation, mining, oil drilling, oil exploration, and oil transportation.

Premiums can also be affected by location. For example, actuarial statistics may indicate that land proximate navigable water is largely “unaffected” by factory recession, but that housing tracts and “subdivisions” comprising houses built by a common builder are often owned by employees in a common sector of the local economy, and highly susceptible to recession or economic downturns in that sector of the economy. If a government number came out relating to durable goods, or profits within that corporation or industrial sector should experience a downturn, such news could conceivably affect the premium of a house in a housing tract or subdivision, while leaving unaffected a house one mile away but situated on waterfront property. Location factors that may be used in the establishment of policy premiums include, but are not limited to political or governmental boundaries such as a country, a state, a province, a county or a city; a housing subdivision comprising geographically related houses built by a common builder, a neighborhood having a recognized name identifying a unique area of a community, a zip code or mailing code, a position relative to a rail line, a position relative to a highway, beachfront property, woodlands property, a position relative to a navigable body of water, a position relative to a commuter train station, a position relative to an airport and a position relative to a government subsidized housing project.

The above list is not intended to be exhaustive, and other factors not discussed herein can be further considered in establishing insurance premiums according to the present invention.

Sale of the Property

According to the step 114, the client decides to sell the insured real property. According to the step 116, the client receives an offer on the property. According to the step 118, the client determines if the offer is greater than the Shelter Value.

According to the step 120, the client sells the property at a sale price greater than the Shelter Value. No indemnity is owed the client, and the policy is dissolved.

If, in the step 118, the offer is below the Shelter Value, then according to the step 122, the client notifies the insurer of the offer and the desire to sell.

According to the step 124, the property is appraised by an agent or entity approved by the insurer. Unless disputed, this Terminal Appraisal will function as the Final Market Value of the property, establishing a lower limit at which a sale will be indemnified. The list of approved appraisers or appraising entities is preferably either listed within the insurance contract, or exists in a separate publication that is incorporated by reference within the policy. As noted, this Terminal Appraisal forms a tentative policy limit, such that the maximum indemnity that can be awarded to the client is the difference between the Shelter Value and the Terminal Appraisal Value (TAV).

If, according to the step 126, the client disputes the Terminal Appraisal Value, then according to the step 128 an alternative formula is used for settling the dispute, and providing the Final Market Value (FMV). At least two possible equations yielding identical results are envisioned. The second Average Square Foot Value “ASFV2” is determined according to the date of the sale. As noted above, this sale date can be the date of signing an agreement to purchase, the date of closing, the listing date, as well as or another specific date. The event establishing the “sale date” for ASFV2 purposes is preferably set forth in the policy. The Final Market Value (FMV) of the real property can then be determined according to equation 2 below:

FMV=MF×ASFV2×SF 2)

The FMV or Final Market Value is used to establish the Maximum Reimbursable Loss covered by the policy. To illustrate, consider the previous example in Step 110 wherein a home was insured at a Shelter Value of $300,000, and the Market Factor MF at the time of purchase was calculated at 1.143. The home is subsequently put on sale during a soft market and when appraised, its Terminal Appraisal Value is only $250,000. However, the home sells for only $223,000. A dispute arises between the client and the insurer. The client seeks an indemnity award of $77,000, the difference between the Shelter Value and the sale value. The insurer, however, offers only $50,000 indemnity, the difference between the Shelter Value and the Terminal Appraisal Value at the time of sale. The client, seeing that the sale would be at a level below the Terminal Appraisal Value seeks a second Terminal Appraisal, which values the home at $221,500. According to this value, the client should be indemnified for the entire loss of $77,000. The sum of $27,000 is in dispute, and the disgruntled client files a legal action alleging insurance fraud, or some other grievance, real or imagined. Within the policy, a dispute resolution process is specified using the FMV or Final Market Value as determined by the ratios of ASFV2 to ASFV1 as the binding figure in settling disputes for which an action or dispute is initiated. The specified publication is examined, and it is determined that the ASFV2 on the sale date was $130.94 dollars per square foot for the client's type of property in that location. Using the originally established Market Factor of 1.143, as established by application of Equation 1, and inserting this value into Equation 2 yields a Final Market Value FMV of $224,500 on the day the client's property was sold. This then forms the Maximum Reimbursable Loss covered by the policy in the dispute resolution process. The client will not be indemnified below this value. Because the client's sale value of $223,000 was below this FMV, the indemnity paid the client will be equal to the Shelter Value of $300,000 minus the FMV of $224,500, for a total indemnity of $75,500. If the FMV were calculated at $223,000 or less, the client would receive the full $77,000 indemnity. However, according to the preferred embodiment, the calculated award will never be more than the difference between the Shelter Value and the Final Market Value. The Shelter Policy is an insurance policy, not a stock option. For ease of illustration, the above examples do not incorporate deductibles or percent coverage. However, those skilled in the art will readily appreciate that these factors could be easily calculated into the above examples.

The above combination of Equation 1 and Equation 2 can be performed in a single step by simple algebraic manipulation according to Equation 3 below:

FMV=Shelter Value×(ASFV2/ASFV1) 3)

Those skilled in the art will therefore understand that equivalent algebraic manipulations of the data can be performed on the same set of data.

By providing alternative means of establishing the market value of a property, one by appraisal, and one by using ASFV publications, the insurer runs the risk of having every client calculate the ASFV after a sale is completed, and select the most advantageous method for determining a market value “after the fact,” thereby raising a dispute whenever it is in their interest to do so. Accordingly, the real estate Shelter Policy will advantageously state the circumstances under which a valid dispute has been raised, giving rise to the alternative calculation of the Final Market Value according to the ASFV data. For example, the policy may require that in order to dispute an aspect of a Terminal Appraisal such as the Terminal Appraisal Value, the agent performing the Terminal Appraisal, etc., a client must seek an alternate appraisal by a qualified appraiser, and notify the insurer in advance of the name of the alternate appraiser, and the date of the alternate appraisal. Further, the clause might specify that for a dispute to be valid, the alternate appraisal value must vary from the Terminal Appraisal Value by a minimum percentage or a minimum total differential. Finally, the client may be required to notify the insurer of the dispute prior to the sale date of the property. By setting forth requisite conditions for a valid dispute, the insurer can prevent clients from raising a bad faith dispute and selecting a “best option” for calculating the Final Market Value “after the fact.” By specifying both a default method and an alternative method for settling a disputed indemnity award, an insurer can reduce expenses in litigation or other dispute resolution procedures.

If, according to step 130, the Offer is greater than the Final Market Value, then, in the step 132, the client sells the property below the Shelter Value, but at an amount greater than the Final Market Value. In step 136, the client is reimbursed the total difference between the Shelter Value and the sale price. The difference is also known as the Basic Loss. As discussed above, this reimbursement is adjusted according to deductibles, percent coverage agreements, or other contractual limitations and adjustments.

Consider the example wherein the Shelter Value was $300,000, the Final Market Value is $250,000, and the sale price is $252,000. The sale price is greater than the FMV, so the client is awarded an indemnity of $48,000, the total difference between the Shelter Value and the sale price. Again, this amount can be modified by deductibles and percent offsets set forth in the policy.

If, according to step 130, the Offer is less than the Final Market Value, then, according to the alternative step 134, the client sells the property at or below the Final Market Value (FMV). Because the FMV establishes a policy limit, in the step 138, the insurer reimburses the client the difference between the Shelter Value and the Final Market Value. The difference is also known as the Maximum Reimbursable Loss. Assume that the Shelter Value was $300,000 and the Final Market Value is determined to be $250,000 in a soft market. However, the client is only able to sell the house for $247,000. Although the difference between the Shelter Value and the sale price is $53,000, the client is only reimbursed $50,000, the difference between the Shelter Value and the FMV. Accordingly, the FMV safeguards the insurer against fraudulent conveyances of real property. For example, if a father sought to convey a house to his daughter at half price, the loss would not be passed on to the insurance company. The owner can only be reimbursed up to the difference between the Shelter Value and the Final Market Value.

The FMV then, protects the insurer by establishing a policy limit. The difference between the Shelter Value and the FMV establishes the Maximum Reimbursable Loss, or the reimbursement limit of the policy. However, an insurer will preferably retain the option of reimbursing the client at an amount greater than this lower reimbursable limit for cost control purposes. Consider for example, the client wishes to sell the real property, but feels that the FMV is a few thousand dollars higher than the client would like. The client expresses hopes of a market recovery, but after several months secures a Terminal Appraisal lower than the previous Terminal Appraisal. The insurer determines that the market is falling, and realizes that by quibbling over a few thousand dollars, the client may postpone sale of the property until the market has fallen even further, thereby increasing the liability of the insurer. Accordingly, the preferred embodiment envisions a process whereby an executive within the insurance company may agree to indemnify the client at an amount greater than that established by the FMV. The same reasoning may be exercised by an insurer desiring to pay out more than the maximum theoretical reimbursement to avoid expensive litigation.

In the above description, the FMV derived from an ASFV was used to determine the indemnity only in circumstances wherein there is a disputed appraisal. However, embodiments are envisioned wherein a Final Market Value derived from an ASFV (Average Square Foot Value) is the primary figure used to establish the policy claim limit, rather than functioning only as a dispute resolution tool in cases wherein the appraisal is challenged. According to this alternative embodiment, an appraisal can function as a dispute resolution tool. Variations on the above process include embodiments wherein multiple appraisal values secured at the time of sale are averaged together, and embodiments wherein a FMV derived from an ASFV is averaged together with one or more appraisal values, either directly, or accorded to a weighted average.

Franchising and Licensing Rights to Sell Real Estate Devaluation Insurance

According to one embodiment, a sales entity is licensed to sell real estate devaluation insurance also described herein as a real estate Shelter Policy. The sales entity can be a realty corporation, an insurance corporation securing a collective license on behalf of all their employees, or an individual person securing a license to offer a real estate Shelter Policy. Because the basic product is envisioned as an insurance contract, according to the preferred embodiment, the corporation securing license will employ persons who possess an insurance license. However, insurance laws vary from state to state and country to country, and embodiments are envisioned wherein a realty agent could be authorized under laws of a state or country to offer a real estate insurance contact to a potential buyer. Alternatively, embodiments are envisioned wherein contact is made by a realty agent, and consummated by an insurance agent.

The franchisee, whether an individual person or a corporation, pays valuable consideration to the franchising/licensing body for the right to offer the insurance product to potential buyers. The terms “franchise” and “license” and associated terms are used interchangeably herein, and include any relevant aspects to both marketing forms.

The licensing fee is advantageously paid in exchange for a future right to offer policies for a predetermined period of time, for example, a year. Individual licenses can be granted to real estate agents, preferably for an annual fee. General franchise fees can be determined by the number of realty agents within a company, the total number of sales in the previous year, or any other reasonable means for estimating future business. In addition to franchise or licensing fees, embodiments are envisioned wherein additional revenues can be collected for every time a Shelter Policy is sold, or every time a Shelter Policy is offered to a home buyer, regardless of whether they chose to protect their property with a Shelter Policy.

The franchise fee can be set according to the number of policy sale offers made by the franchisee to potential clients, or the number of policies actually sold.

A unique feature of the above licensing scheme is that according to several alternative embodiments, fees are paid to the franchiser regardless of the number of policies sold.

Within the foregoing description, many specific details commonly understood by those skilled it the art have not been recited so as to not needlessly obscure many of the essential features of the present invention. In other instances, some non-essential details have been described in conjunction with specific embodiments of the claimed invention to better enable those skilled in the art to make and use the claimed invention. For example, equations are offered within the specification and claims, many terms of which can be eliminated by algebraic manipulation, yielding identical values or results. Such use of mathematics is simply a means of illustrating equivalent embodiments of the present invention. Similarly, various examples herein have been described above in terms of private home ownership. One skilled in the art will readily appreciate that the principles described herein can be applied to a wide variety of real estate types, including commercial real estate, warehouses, and undeveloped property. The specific recitation of residential property is therefore offered for exemplary purposes, and is not intended to limit the application of the present invention, which fully envisions application with other types of real estate. Accordingly, these specific examples are not intended, and should not be construed as limiting the full range of applications. On the contrary, it will be readily apparent to one skilled in the art that the claimed invention may cover alternative embodiments and equivalent methods without departing from the spirit and scope of the foregoing description in view of the claims appended hereto.

What is claimed as new and desired to be protected by Letters Patent, as set forth in the appended claims is:

1. A method of protecting a real estate investor comprising the steps:
a) offering a real estate investor an insurance contract insuring against a loss incurred through the sale of real property, a loss being defined as a sale of said real property at a Future Sale Price below a Shelter Value, a Basic Loss being defined according to the equation
Basic Loss=Shelter Value minus Future Sale Price;
b) establishing said Shelter Value for said real property on an initial day;
c) providing at least one method within said insurance contract for determining, at a future time, a Final Market Value for said real property, wherein said Final Market Value is used to determine a Maximum Reimbursable Loss according to the equation:
Maximum Reimbursable Loss=Shelter Value minus Final Market Value; and
d) accepting said insurance contract; wherein an indemnity award to said real estate investor is to be calculated from a lesser of said Basic Loss and said Maximum Reimbursable Loss, wherein said real property is a particular type of property.

2. The method according to claim 1 further comprising the step of specifying a time period in which said insurance contract is in force.

3. The method according to claim 2 wherein said time period is at least one month.

4. The method according to claim 1 further comprising the step of requiring a payment of valuable consideration in exchange for said insurance contract, wherein said valuable consideration is a fixed amount set forth in said insurance contract.

5. The method according to claim 4 wherein said valuable consideration is payable in monthly premium payments.

6. The method according to claim 4 wherein said valuable consideration is payable in a lump sum.

7. The method according to claim 6 further comprising the step of taking out a loan for said real property, wherein said loan includes a sum sufficient for said lump sum.

8. The method according to claim 1 further comprising the step of purchasing said real property, the step of purchasing being performed by said client for a purchase price, wherein the Shelter Value is derived from said purchase price of said real property

9. The method according to claim 1 further comprising the step of appraising said real property at an Initial Appraisal Value, wherein the Shelter Value is derived from said Initial Appraisal Value of said real property.

10. The method according to claim 9 further comprising the step of requiring that said step of appraising said real property at said Initial Appraisal Value be performed within a predetermined number of days of said step of accepting said insurance contract.

11. The method according to claim 1 further comprising the steps:
a) identifying a reliable source of Average Square Foot Values for property of said particular type of property; and
b) determining from said reliable source a first Average Square Foot Value for real property of said particular type in a predetermined region proximate said real property on a day proximate said initial day, said first Average Square Foot Value being ASFV1.

12. The method according to claim 11 further comprising the steps:
a) selling said real property on a sale date at said Future Sale Price wherein said Future Sales Price is less than the Shelter Value;
b) determining from said reliable source a second Average Square Foot Value for real property of said particular type in said predetermined region on a day proximate said sale date, said second Average Square Foot Value being ASFV2; and
c) determining a Final Market Value according to the equation FMV=Shelter Value×(ASFV2/ASV1), wherein FMV is said Final Market Value.

13. The method according to claim 12 wherein the Future Sale Price is greater than the Final Market Value, the method further comprising the step of paying said real estate investor an indemnity derived from said Basic Loss.

14. The method according to claim 13 wherein the indemnity is adjusted by subtracting a deductible amount from the Basic Loss.

15. The method according to claim 13 wherein the indemnity is between one percent and one hundred percent of the Basic Loss according to a percent coverage clause in said insurance contract.

16. The method according to claim 12 wherein the Final Market Value is greater than the Future Sale Price, the method further comprising the step of paying the real estate investor an indemnity derived from said Maximum Reimbursable Loss.

17. The method according to claim 16 wherein the indemnity is adjusted by subtracting a deductible amount from the Maximum Reimbursable Loss.

18. The method according to claim 16 wherein the indemnity is between one percent and one hundred percent of the Maximum Reimbursable Loss according to a percent coverage clause in said insurance contract.

19. The method according to claim 1 further comprising the steps:
a) selling said real property at a Future Sale Price less than said Shelter Value; and
b) appraising said real property at a Terminal Appraisal Value by an appraisal agent, the Terminal Appraisal Value establishing a Final Market Value.

20. The Method according to claim 19 further comprising the step of publishing within said insurance policy a means for identifying approved appraisal agents.

21. The method according to claim 19 wherein the Future Sale Price is greater than the Final Market Value, the method further comprising the step of paying said real estate investor an indemnity derived from said Basic Loss.

22. The method according to claim 21 wherein the indemnity is adjusted by subtracting a deductible amount from the Basic Loss.

23. The method according to claim 21 wherein the indemnity is between one percent and one hundred percent of the Basic Loss according to a percent coverage clause in said insurance contract.

24. The method according to claim 19 wherein the Final Market Value is greater than the Future Sale Price, the method further comprising the step of paying the real estate investor an amount derived from said Maximum Reimbursable Loss.

25. The method according to claim 24 wherein the indemnity is adjusted by subtracting a deductible amount from the Maximum Reimbursable Loss.

26. The method according to claim 24 wherein the indemnity is between one percent and one hundred percent of the Maximum Reimbursable Loss according to a percent coverage clause in said insurance contract.

27. The method according to claim 1 wherein said insurance policy specifies at least two methods for determining a Final Market Value.

28. The method according to claim 27 wherein a real estate investor selects a preferred method for determining said Final Market Value from among said at least two methods for determining said Final Market Value.

29. The Method according to claim 27 wherein said insurance contract provides that said Final Market Value is to be determined according to a default method if said real estate investor does not dispute said default method, and that said Final Market Value is to be determined according to a substitute method if said real estate investor raises a valid dispute with respect to an aspect of said default method.

30. The Method according to claim 29 further comprising the step of selling said property on a sale date.

31. The method according to claim 30 wherein the default method for determining a Final Market Value comprises the step of appraising said real property at a Terminal Appraisal Value by an appraisal agent at a time proximate said sale date, the Terminal Appraisal Value establishing said Final Market Value.

32. The method according to claim 30 wherein the substitute method is derived from the equation:
FMV=Shelter Value×(ASFV2/ASFV1)
wherein FMV is the Final Market Value, ASFV1 is the Average Square Foot Value of said particular type of real property within a predetermined region proximate said real property and within a predetermined period of time of said initial day, and ASFV2 is the Average Square Foot Value of said particular type of real property in said predetermined region, and wherein said ASFV2 is determined according to said sale date of said real property.

33. The method according to claim 30 wherein the default method is derived from the equation:
FMV=Shelter Value×(ASFV2/ASFV1)
wherein FMV is the Final Market Value, ASFV1 is the Average Square Foot Value of said particular type of real property within a predetermined period of time of a day wherein said Shelter Value is determined and said particular type of property is in a predetermined region proximate said real property, and ASFV2 is the Average Square Foot Value of said particular type of real property in said predetermined region proximate said real property, and wherein said ASFV2 is determined on said sale date of said real property.

34. The method according to claim 30 wherein the substitute method for determining a Final Market Value comprises the step of appraising said real property at a Terminal Appraisal Value by an appraisal agent, the Terminal Appraisal Value establishing said Final Market Value.

35. A method of insuring a real estate investor against a market devaluation of real property comprises the steps:
a) offering said real estate investor an insurance contract for protecting said real estate investor against a market devaluation of said real property;
b) establishing a Shelter Value for said real property within said insurance contract;
c) promising to reimburse said real estate investor an indemnity calculated from the Shelter Value minus a Future Sale Price of said real property if a Future Sale Value is less than said Shelter Value; and
d) protecting an underwriter of said insurance contract against a sale of said real property below a Final Market Value of said real property, wherein a Maximum Reimbursable Loss that can be awarded said client is derived from the formula:
Maximum Reimbursable Loss=Shelter Value minus Final Market Value.

36. The method according to claim 35 wherein the Final Market Value is determined by a Terminal Appraisal of the property at a time proximate a sale date of said real property.

37. The method according to claim 36 wherein the Final Market Value determined by a Terminal Appraisal is a default Final Market Value, the method further comprising the steps:
a) raising a valid dispute against the default Final Market Value; and
b) providing a substitute Final Market Value.

38. The method according to claim 37 wherein the substitute Final Market Value is determined by the equation:
Final Market Value=Shelter Value×(ASFV2/ASFV1)
wherein ASFV2 and ASFV1 are respectively the Average Square Foot Values of property of a same type as said real property and proximate said real property, ASFV2 being derived from a value corresponding to a day of sale of said real property, and wherein ASFV1 is derived from a value corresponding to a date corresponding to a creation of said Shelter Value.

39. The method according to claim 35 wherein the Final Market Value is determined by the equation:
Final Market Value=Shelter Value×(ASFV2/ASFV1)
wherein ASFV2 and ASFV1 are respectively the Average Square Foot Values of property of a same type as said real property and proximate said real property, ASFV2 being derived from a value corresponding to a day of sale of said real property, and wherein ASFV1 is derived from a value corresponding to a date corresponding to a creation of said Shelter Value.

40. The method according to claim 39 wherein the Final Market Value is a default Final Market Value, the method further comprising the step:
a) raising a valid dispute against the default Final Market Value; and
b) providing a substitute Final Market Value.

41. The method according to claim 40 wherein the substitute Final Market Value is determined by a Terminal Appraisal of the property at a time proximate a sale date of said real property.
